(19) United States
(12) Patent Application Publication
(10) Pub. No.: US 2014/0215133 A1
(43) Pub. Date: Jul. 31, 2014

(54) MEMORY SYSTEM AND RELATED BLOCK MANAGEMENT METHOD

(71) Applicant: SAMSUNG ELECTRONICS CO., LTD., SUWON-SI (KR)

(72) Inventors: YOUNGIL SEO, SUWON-SI (KR); JUNGHO YUN, SEOUL (KR); WONCHUL LEE, YONGIN-SI (KR); DAWOON JUNG, HWASEONG-SI (KR)

(73) Assignee: SAMSUNG ELECTRONICS CO., LTD., SUWON-SI (KR)

(21) Appl. No.: 14/082,209

(22) Filed: Nov. 18, 2013

(30) Foreign Application Priority Data
Jan. 29, 2013 (KR) 10-2013-0010019

(51) Int. Cl. G06F 12/02

(52) U.S. Cl. CPC G06F 12/0246
USPC 711/103

(57) ABSTRACT

A memory system manages memory blocks of a nonvolatile memory device by determining at least one memory block property of a selected memory block among the multiple memory blocks in the nonvolatile memory device, storing memory block property information indicating the at least one memory block property, arranging a free memory block list based on the stored memory block property information, and designating a free memory block from the arranged free memory block list as an active memory block, wherein the designation of the free memory block as an active memory block is based on an ordering of the free memory block list.

### CROSS-REFERENCE TO RELATED APPLICATIONS

This application claims priority under 35 U.S.C. §119 to Korean Patent Application No. 10-2013-0010019 filed on Jan. 29, 2013, the subject matter of which is hereby incorporated by reference.

### BACKGROUND OF THE INVENTION

The inventive concept relates generally to electronic memory technologies. More particularly, certain embodiments of the inventive concept relate to memory systems and block management methods for the memory systems.

Memory devices are generally subject to deterioration according to usage. In some devices, deterioration may occur on a memory cell by memory cell basis. For example, individual memory cells in a flash memory may fail after they are programmed, erased, or read a predetermined number of times.

To prevent some memory cells from failing well before others, memory devices often implement so-called wear-leveling schemes to ensure that memory cells are used—and therefore wear out—at a similar rate. Such wear-leveling schemes typically keep track of the number of access operations (e.g., erase and/or program operations) performed on each memory cell or group of memory cells (e.g., a memory block), and they select memory cells to be programmed or erased based on the number. For instance, a memory block that has been programmed or erased fewer times may be selected so that some memory blocks are not erased substantially more than others.

A drawback of conventional wear-leveling schemes is that they generally ignore small variations between individual memory cells. For instance, by equalizing the number of access operations performed on different memory cells, these schemes assume that the memory cells are destined to endure approximately the same number of access operations, even though they may in fact differ substantially in their actual endurance. Consequently, these schemes may lead to relatively high bit error rates (BERs) and early failure for some memory blocks and relatively low BERs and later failure for others.

### SUMMARY OF THE INVENTION

In one embodiment of the inventive concept, a method is provided for managing memory blocks in a memory system comprising a nonvolatile memory device. The method comprises determining at least one memory block property of a selected memory block among the multiple memory blocks in the nonvolatile memory device, storing memory block property information indicating the at least one memory block property, arranging a free memory block list based on the stored memory block property information, and designating a free memory block from the arranged free memory block list as an active memory block, wherein the designation of the free memory block as an active memory block is based on an ordering of the free memory block list.

In another embodiment of the inventive concept, a memory system comprises a nonvolatile memory device comprising multiple memory blocks and a meta area, and a memory controller configured to control the nonvolatile memory device. The meta area stores erase count information, a ready-to-use list of memory blocks, a long term list of memory blocks, and memory block retry information for memory blocks in the ready-to-use list and the long term list. The memory controller performs a wear-leveling operation on the memory blocks using the erase count and the memory block retry information. The ready-to-use list is a list of memory blocks each having a relatively low threshold voltage offset, the long term list is a list of memory blocks each having a relatively high threshold voltage offset, and the memory block retry information is obtained from read retry operations performed on the memory blocks in the ready-to-use list and the long term list.

These and other embodiments of the inventive concept can potentially improve the reliability of a nonvolatile memory device by performing wear leveling according to both usage information of memory blocks, as well as operational characteristics of the memory blocks.

### BRIEF DESCRIPTION OF THE DRAWINGS

The drawings illustrate selected embodiments of the inventive concept. In the drawings, like reference numbers indicate like features.

FIG. 1 is a memory block diagram illustrating a memory system according to an embodiment of the inventive concept.

FIG. 2 is a diagram illustrating life-cycle of memory blocks illustrated in FIG. 1.

FIG. 3 is a diagram illustrating a read retry operation of a memory block having memory cells with relatively low threshold voltage offsets.

FIG. 4 is a diagram illustrating a read retry operation of a memory block having memory cells with relatively high threshold voltage offsets.

FIG. 5 is a diagram illustrating a method of managing free memory blocks according to an embodiment of the inventive concept.

FIG. 6 is a diagram illustrating a method of sorting a ready-to-use list of memory blocks according to an embodiment of the inventive concept.

FIG. 7 is a diagram illustrating a method of sorting a long term list of memory blocks according to an embodiment of the inventive concept.

FIG. 8 is a flowchart illustrating a method of performing wear-leveling in a memory system according to an embodiment of the inventive concept.

FIG. 9 is a flowchart illustrating a method of performing block management in a memory system according to an embodiment of the inventive concept.

FIG. 10 is a memory block diagram illustrating a solid state drive according to an embodiment of the inventive concept.

FIG. 11 is a memory block diagram illustrating an eMMC according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and/or the present specification and will not be interpreted in an idealized or overly formal sense unless expressly so defined herein.

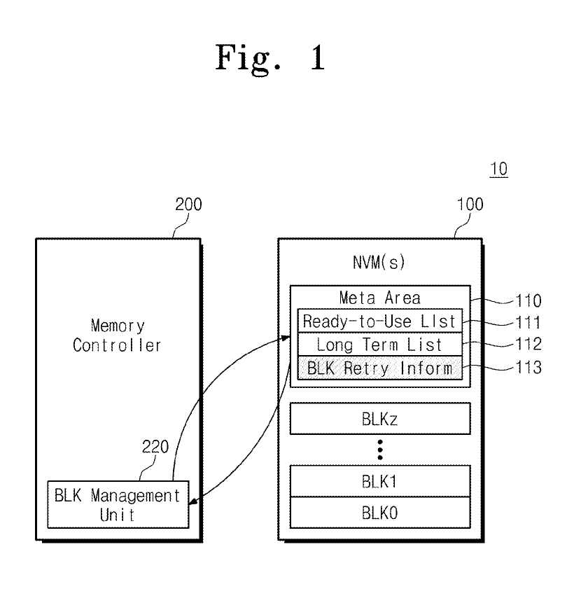

FIG. 1 is a memory block diagram illustrating a memory system 10 according to an embodiment of the inventive concept.

Referring to FIG. 1, memory system 10 comprises at least one nonvolatile memory device 100 and a memory controller 200 controlling nonvolatile memory device 100.

For explanation purposes, it will be assumed that nonvolatile memory device 100 is a NAND flash memory device, although the inventive concept is not limited to a NAND flash memory device. For example, concepts described with reference to nonvolatile memory device 100 could also be applied to a NOR flash memory device, a Resistive Random Access Memory (RRAM) device, a Phase-Change Memory (PRAM) device, a Magnetroresistive Random Access Memory (MRAM) device, a Ferroelectric Random Access Memory (FRAM) device, a Spin Transfer Torque Random Access Memory (STT-RAM), and the like. Further, the nonvolatile memory device can be implemented to have a three-dimensional array structure. The inventive concept may be applied to a Charge Trap Flash (CTF) memory device including a charge storage layer formed of an insulation film as well as a flash memory device including a charge storage layer formed of a conductive floating gate.

Nonvolatile memory device 100 comprises multiple memory blocks BLK0 to BLKz, each comprising multiple cell strings. Each cell string typically comprises at least one string selection transistor, multiple memory cells, and at least one ground selection transistor which are connected in series. Each of the memory cells may store at least one bit of data, and may be driven by a voltage transferred through a corresponding one of word lines.

A meta area 110 stores management information used to manage nonvolatile memory device 100. Meta area 110 stores a ready-to-use list 111, a long term list 112, and memory block retry information 113. Ready-to-use list 111 is a list of memory blocks having a memory cells with relatively low threshold voltage offsets, and long term list 112 is a list of memory blocks having memory cells with relatively high threshold voltage offsets.

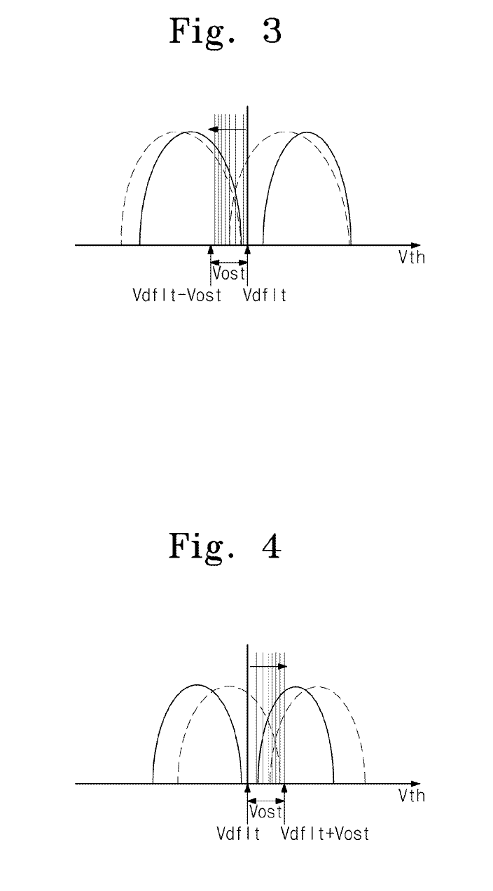

The relatively low and high threshold voltage offsets are determined through a read retry operation in which a sequence of different read voltages are applied to selected memory cells until the memory cells are successfully read. The read retry operation typically applies an initial default read voltage to the selected memory cells and then either increases or decreases the default read voltage until a desired outcome is achieved. For instance, in an example illustrated in FIG. 3, a read voltage is decreased until it falls below an upper one of two adjacent threshold voltage distributions of the selected memory cells. Similarly, in an example illustrated in FIG. 4, a read voltage is increased until it rises above a lower one of two adjacent threshold voltage distributions of the selected memory cells.

Where the read voltage required to successfully read the selected memory cells is greater than the default read voltage, the selected memory cells (or alternatively, memory block) are deemed to have a relatively high threshold voltage offset. More particularly, their threshold voltages are deemed to have a positive offset relative to the default read voltage. On the other hand, where the read voltage required to successfully read the selected memory cells is less than the default read voltage, the selected memory cells (or alternatively, memory block) are deemed to have a relatively low threshold voltage offset. More particularly, their threshold voltages are deemed to have a negative offset relative to the default read voltage. The use of the terms “relatively low” and “relatively high” in this context merely indicates that the relatively low threshold voltage offset is below the relatively high threshold voltage offset.

Memory block retry information 113 comprises an offset voltage and address information for a memory block. The offset voltage indicates actual offset of the read voltage required to successfully read the selected memory cells.

Ready-to-use list 111 and long term list 112 may be determined based on memory block retry information 113. For example, where an offset voltage is a negative value (e.g., a memory cell has a relatively low threshold voltage offset), a memory block corresponding to address information may be included in ready-to-use list 111. On the other hand, where an offset voltage is a positive value (e.g., a memory cell has a relatively high threshold voltage offset), a memory block corresponding to address information may be included in long term list 112.

Memory controller 200 controls nonvolatile memory device 100. Memory controller 200 comprises a memory block management unit 220 to manage the memory blocks BLK0 to BLKz.

Memory block management unit 220 manages wear-leveling of the memory blocks BLK0 to BLKz based on memory block usage information and property information of memory cells (or, memory blocks). In other words, in contrast to certain conventional approaches that merely use memory block usage information, memory block management unit 220 manages wear-leveling based on the usage and the properties of memory cells and/or memory blocks. The memory block usage information typically comprises an erase count, a program count, and/or a read count. Although not shown in FIG. 1, the memory block usage information may be stored at meta area 110. Also, the memory cell property information may be memory block retry information 113 associated with retention or endurance.

After a read retry operation is performed on a memory block, memory block management unit 220 stores memory block retry information 113 associated with the read retry operation in meta area 110. Memory block management unit 220 sorts ready-to-use list 111 and long term list 112 based on memory block retry information 113. Memory block management unit 220 may assign a memory block, having the best relatively low threshold voltage offset, from among free memory blocks to an active memory block for a data write operation.

In contrast to conventional systems, memory system 10 may perform wear-leveling in consideration of both an erase count and memory cell properties, such as a threshold voltage offset. This can be accomplished through the use of ready-to-use list 111 and long term list 112, as will be apparent from the description that follows.

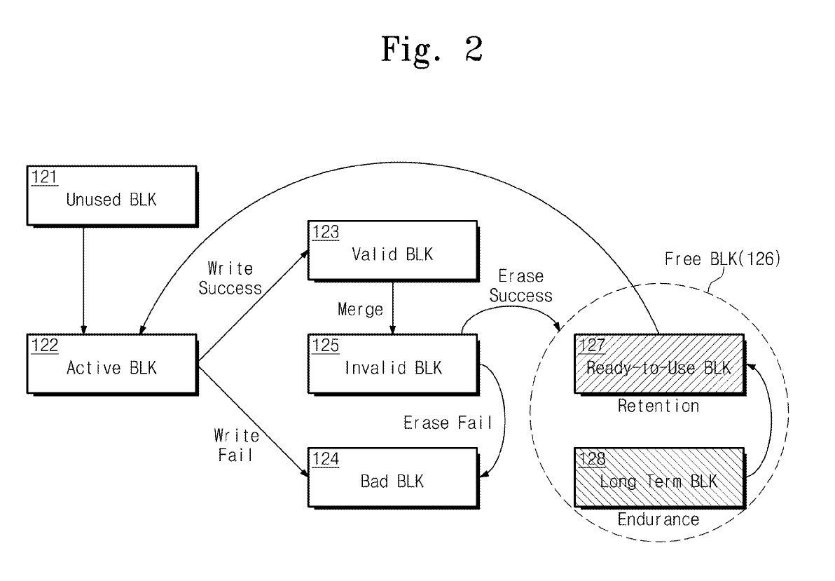

FIG. 2 is a diagram illustrating life-cycle of blocks BLK0 to BLKz of FIG. 1.

Referring to FIG. 2, first, an unused block 121 is in an erase state. Unused block 121 can be designated as an active memory block 122 in which data is to be written. If data is successfully written in active memory block 122 assigned, active memory block 122 may be designated as a valid memory block 123. Where a write operation on active memory block 122 fails, the active memory block may be designated as a bad memory block 124. Otherwise, if data of valid memory block 123 is determined to be invalid in a merge operation, valid memory block 123 may be designated as an invalid memory block 125.

If an erase operation is successfully performed, invalid memory block 125 may be designated as a free memory block 126. Free memory block 126 may be designated as a ready-to-use block 127 or a long term block 128 according to a memory cell property (e.g., a threshold voltage offset determined by a read retry operation). Ready-to-use block 127 is a free memory block comprising memory cells each having a relatively low threshold voltage offset, and the long term block 128 may be a free memory block comprising memory cells each having an relatively high threshold voltage offset. Ready-to-use block 127 may be newly designated as an active memory block 122. For example, ready-to-use block 127 having a lowest threshold voltage offset may be designated as an active memory block 122. Long term block 128 may be designated as a ready-to-use block 127 after a predetermined lapse of time.

Meanwhile, if an erase operation fails, invalid memory block 125 may be designated as a bad memory block 124. In some situations, although not shown in FIG. 2, the bad memory block 124 can be designated as a free memory block 126 if an erase operation is successfully performed under a predetermined condition.

FIG. 3 is a diagram illustrating a read retry operation for a memory block having a relatively low threshold voltage offset, and FIG. 4 is a diagram illustrating a read retry operation for a memory block having a relatively high threshold voltage offset. In each of FIGS. 3 and 4, solid curves represent ideal threshold voltage distributions of selected memory cells, and dotted curves represent actual threshold voltage distributions that may exist among selected memory cells. As indicated by a tallest vertical line in each of FIGS. 3 and 4, a default read voltage Vdflt falls between the ideal threshold voltage distributions, and could be used to read the selected memory cells if their threshold voltage distributions did not deviate from the ideal. Meanwhile, shorter vertical lines indicate read voltages used in successive iterations of the read retry operation. A threshold voltage offset Vost represents a difference between the default read voltage Vdflt and a read voltage that results in successful reading of the selected memory cells.

Referring to FIG. 3, the read retry operation proceeds by decreasing the read voltage from default read voltage Vdflt in successive iterations. The read retry operation is generally successful once the read voltage falls below an upper one of two threshold voltage distributions. Once this occurs, a memory block property is determined to be “relatively low threshold voltage offset”, and corresponding block retry information is stored as memory block retry information 113. Memory block retry information 113 may be, for instance, a bit or a value indicative of the relatively low threshold voltage offset, or it may be a read retry number corresponding to the offset voltage Vost. As used in this description, the term “memory block property” denotes an operational characteristic of memory cells belonging to a memory block, as opposed to mere historical information, such as an erase count, for example.

Referring to FIG. 4, the read retry operation proceeds by increasing the read voltage from default read voltage Vdflt in successive iterations. The read retry operation is generally successful once the read voltage rises above a lower one of two threshold voltage distributions. Once this occurs, a memory block property is determined to be “relatively high threshold voltage offset”, and corresponding block retry information is stored as memory block retry information 113. Memory block retry information 113 may be, for instance, a bit or a value indicative of the relatively high threshold voltage offset, or it may be a read retry number corresponding to the offset voltage Vost.

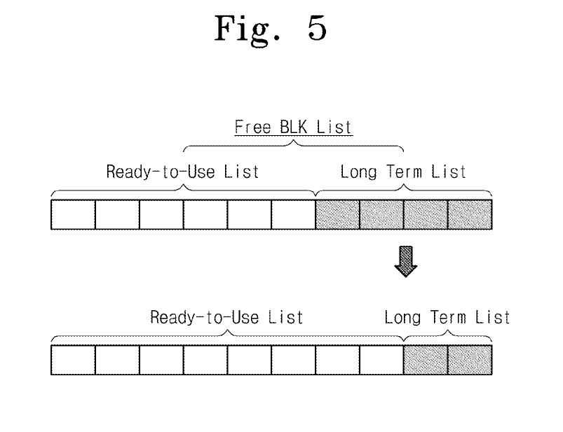

FIG. 5 is a diagram illustrating a method of managing free memory blocks according to an embodiment of the inventive concept.

Referring to FIG. 5, a free memory block list comprises a ready-to-use list and a long term list. The ready-to-use list indicates memory blocks having a relatively low threshold voltage offset. The long term list comprises memory blocks having an relatively high threshold voltage offset. The memory blocks listed in the long term list may be subsequently transferred to the ready-to-use list after a predetermined lapse of time, e.g., several weeks or months.

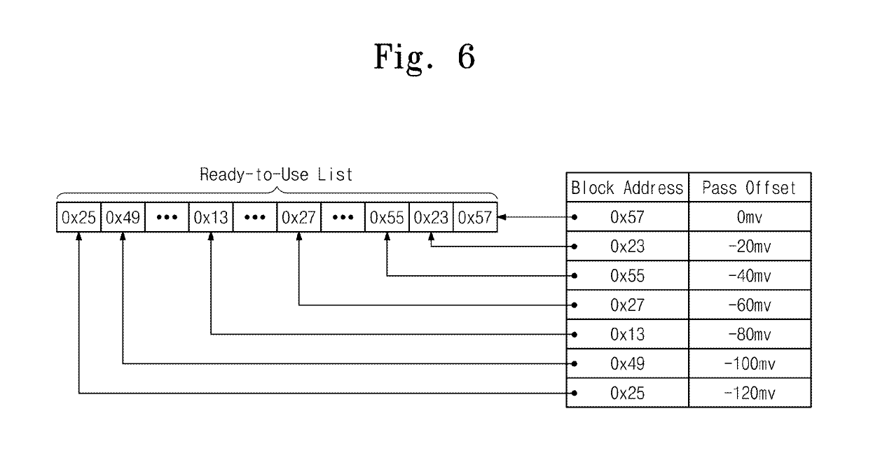

FIG. 6 is a diagram illustrating a method of sorting a ready-to-use list of memory blocks according to an embodiment of the inventive concept.

Referring to FIG. 6, the ready-to-use list is sorted sequentially according to a determined threshold voltage offset, starting with a memory block address “0x25” having a largest threshold voltage offset. The first memory block in the list will be the first memory block to be re-designated as an active memory block according to the life-cycle illustrated in FIG. 2.

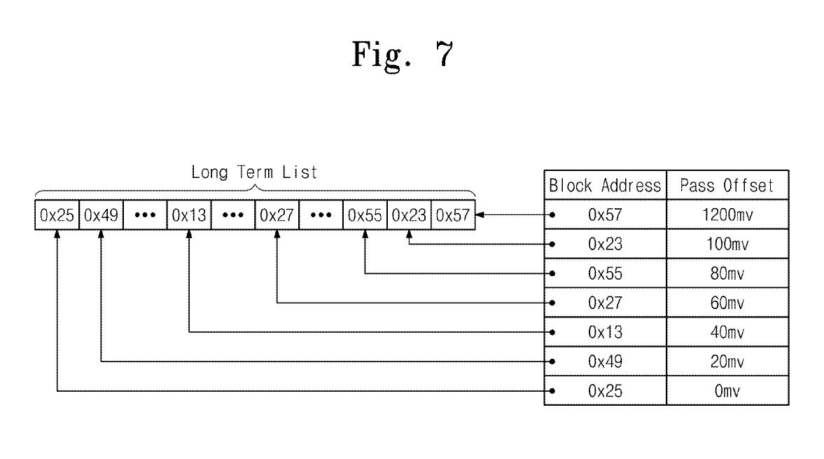

FIG. 7 is a diagram illustrating a method of sorting a long term list of memory blocks according to an embodiment of the inventive concept.

Referring to FIG. 7, the long term list is sorted sequentially according to a determined threshold voltage offset, starting with a memory block address “0x25” having a smallest threshold voltage offset. The first memory block in the list will be the first memory block to be re-assigned to the ready-to-use list according to the life-cycle illustrated in FIG. 2.

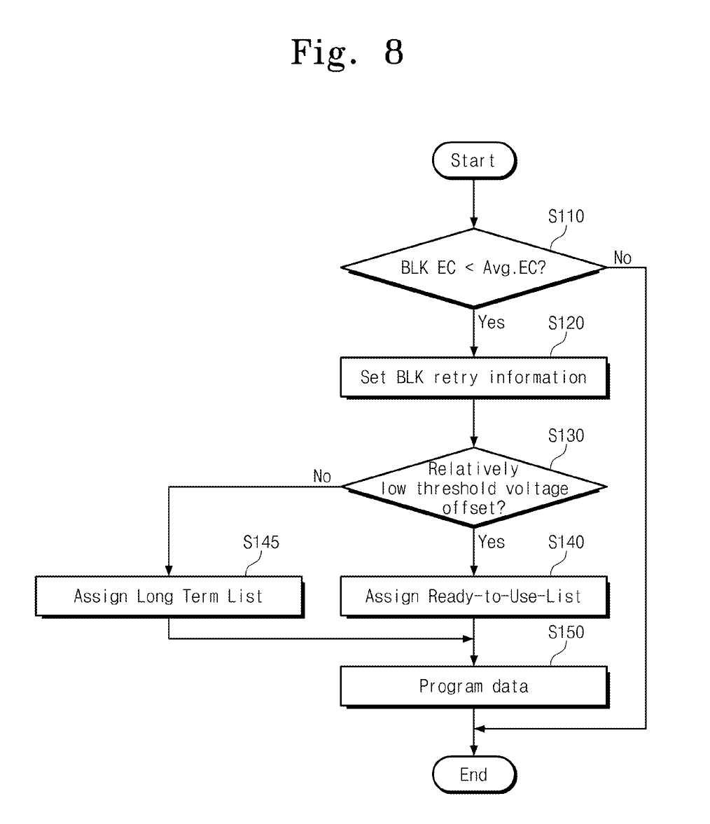

FIG. 8 is a flowchart illustrating a method of performing wear-leveling in a memory system according to an embodiment of the inventive concept.

Referring to FIGS. 1 to 8, the method determines whether an invalid memory block erase count (BLK EC) is less than an average erase count (Avg. EC) (S110). If the memory block erase count is less than the average erase count, garbage collection may be performed on the memory block. The garbage collection operation is intended to reclaim invalid memory blocks as free memory blocks. The garbage collection operation may comprise, for instance, erasing an invalid memory block and performing a read retry operation on the erased memory block. During the read retry operation, the method may determine and set memory block retry information 113, as illustrated for instance, in FIGS. 3 and 4 (S120).

Thereafter, the method determines whether the memory block retry information 113 indicates that the memory block has a relatively low or relatively high threshold voltage offset (S130). If so, the memory block is assigned to the ready to use list (S140), and if not, the memory block is assigned to the long term list (S145).

Following operations S140 and S145, data is programmed in a first memory block in the ready to use list (S150).

Although the above description assumes that a memory block property is determined by a read retry operation, the inventive concept is not limited to this type of determination. For example, in alternative embodiments a memory block property may be determined according to other methods.

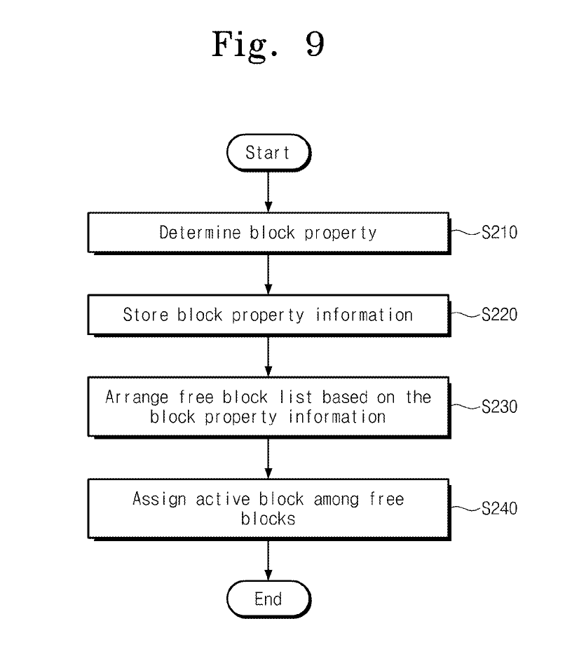

FIG. 9 is a flowchart illustrating a method of managing memory blocks in a memory system according to an embodiment of the inventive concept.

Referring to FIG. 9, the method determines whether a memory block has a relatively low threshold voltage offset or a relatively high threshold voltage offset (S210). Under these circumstances, the threshold voltage offset may be expressed, for example, as a numerical value. Next, memory block property information, including a the threshold voltage offset, is stored (S220). Then, a free memory block list is arranged (e.g., sorted) based on the stored memory block property information (S230). Here, the free memory block list may be arranged so that a memory block having a lower threshold voltage offset (i.e., more negative or less positive) is to be preferentially designated as an active memory block. Then, an active memory block is selected from the free memory blocks arranged to program data (S240).

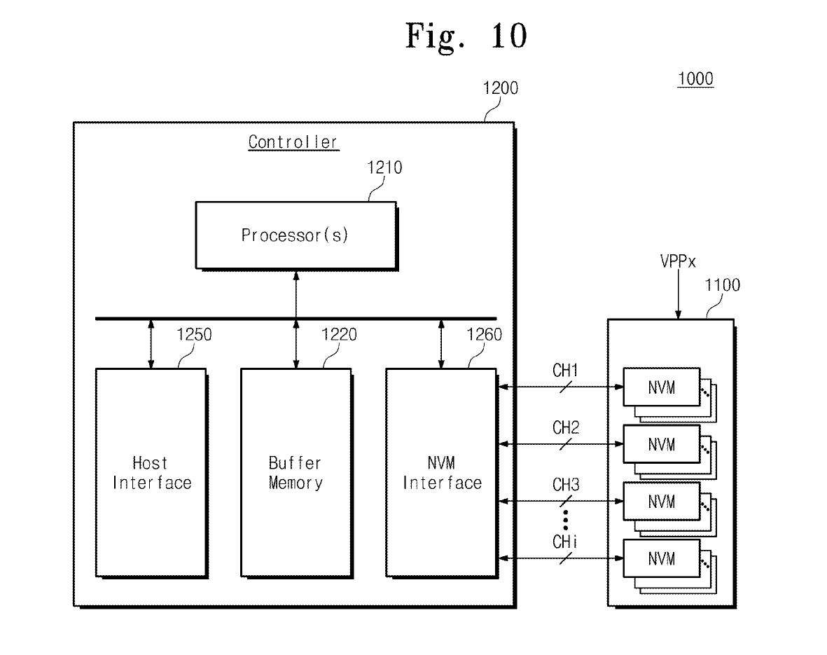

FIG. 10 is a memory block diagram illustrating a solid state drive according to an embodiment of the inventive concept.

Referring to FIG. 10, a solid state drive (SSD) 1000 comprises multiple flash memory devices 1100 and an SSD controller 1200. Flash memory devices 1100 may be configured to receive an external high voltage VPPx. A wear-leveling method described with reference to FIGS. 1 to 9 may be applied to each flash memory device 1100. SSD controller 1200 may be connected to flash memory devices 1100 via multiple channels CH1 to CHi. SSD controller 1200 comprises at least one processor 1210, a buffer memory 1220, a host interface 1250, and a flash interface 1260.

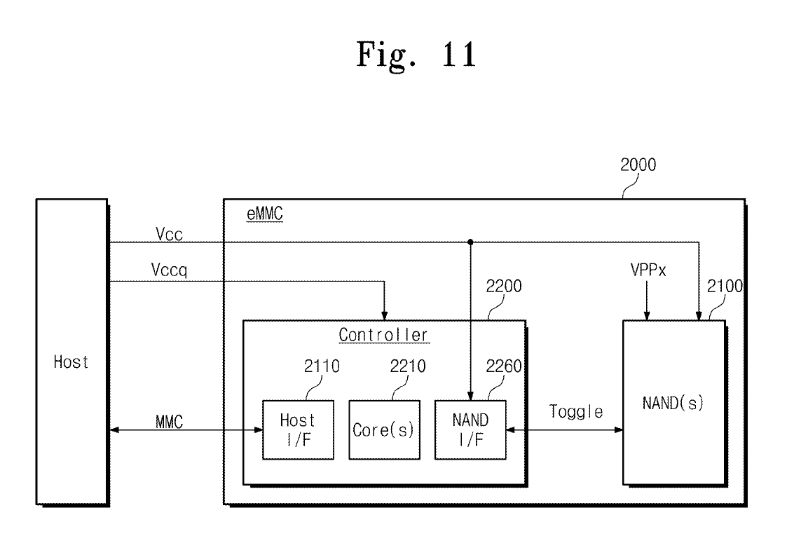

FIG. 11 is a memory block diagram illustrating an embedded MMC (eMMC) according to an embodiment of the inventive concept.

Referring to FIG. 11, an eMMC 2000 comprises at least one NAND flash memory device 2100 and controller 2200 integrated in a chip. NAND flash memory device 2100 may be a single data rate (SDR) NAND flash memory device or a double data rate (DDR) NAND flash memory device. In example embodiments, the NAND flash memory device 2100 may comprise NAND flash memory chips. Herein, the NAND flash memory device 2100 may be implemented by stacking the NAND flash memory chips at one package (e.g., FBGA, Fine-pitch Ball Grid Array, etc.). A wear-leveling or block management method described with reference to FIGS. 1 to 9 may be applied to each NAND flash memory device.

Controller 2200 may be connected with the flash memory device 2100 via multiple channels. Controller 2200 comprises at least one controller core 2210, a host interface 2110, and a NAND interface 2260. Controller core 2210 controls overall operations of eMMC 2000. Host interface 2110 may be configured to interface between controller 2210 and a host. NAND interface 2260 is configured to provide an interface between NAND flash memory device 2100 and controller 2200. Host interface 2110 may be a parallel interface (e.g., an MMC interface). In other example embodiments, host interface 2110 of eMMC 2000 may be a serial interface (e.g., UHS-II, UFS, etc.).

EMMC 2000 typically receives power supply voltages Vcc and Vccq from the host. Herein, the power supply voltage Vcc (about 3.3V) may be supplied to the NAND flash memory device 2100 and the NAND interface 2260, and the power supply voltage Vccq (about 1.8V/3.3V) may be supplied to controller 2200.

EMMC 2000 is applicable to small-sized and low-power mobile products (e.g., Galaxy S series, Galaxy note series, iPhone, iPad, Nexus, etc.).

The foregoing is illustrative of embodiments and is not to be construed as limiting thereof. Although a few embodiments have been described, those skilled in the art will readily appreciate that many modifications are possible in the embodiments without materially departing from the scope of the inventive concept. Accordingly, all such modifications are intended to be included within the scope of the inventive concept as defined in the claims.

What is claimed is:

1. A method of managing memory blocks in a memory system comprising a nonvolatile memory device, comprising:
determining at least one memory block property of a selected memory block among the multiple memory blocks in the nonvolatile memory device;
storing memory block property information indicating the at least one memory block property;
arranging a free memory block list based on the stored memory block property information; and
designating a free memory block from the arranged free memory block list as an active memory block, wherein the designation of the free memory block as an active memory block is based on an ordering of the free memory block list.

2. The method of claim 1, wherein the at least one memory block property is determined by performing a read retry operation on the selected memory block.

3. The method of claim 2, wherein the memory block property indicates that the selected memory cell has a relatively low threshold voltage offset.

4. The method of claim 2, wherein the memory block property indicates that the selected memory cell has a relatively high threshold voltage offset.

5. The method of claim 2, wherein the memory block property information comprises memory block retry information of the read retry operation.

6. The method of claim 1, wherein the free memory block list comprises a ready-to-use list and a long term list, wherein the ready-to-use list is a list of memory blocks each having a relatively low threshold voltage offset, and the long term list is a list of memory blocks each having a relatively high threshold voltage offset.

7. The method of claim 6, wherein the arranging the free memory block list based on the memory block property information comprises:
assigning the selected memory block to the ready-to-use list where a read retry operation of the selected memory block indicates that the selected memory block has a relatively low threshold voltage offset.

8. The method of claim 7, wherein the arranging the free memory block list based on the memory block property information further comprises:
arranging the ready-to-use list according to a threshold voltage offset of each memory block in the ready-to-use list.

9. The memory block management method of claim 6, wherein the arranging the free memory block list based on the memory block property information comprises:
where a read retry operation of the selected memory block indicates that the selected memory block has a relatively high threshold voltage offset.

10. The memory block management method of claim 9, wherein the arranging the free memory block list based on the memory block property information further comprises:
arranging the long term list according to a threshold voltage offset of each memory block in the long term list.

11. The memory block management method of claim 6, wherein the arranging the free memory block list based on the memory block property information comprises:
reassigning a memory block in the long term list to the ready-to-use list based on an elapsing of a predetermined time.

12. The memory block management method of claim 6, further comprising identifying a memory block having a lowest threshold voltage offset among memory blocks in the free memory block list, and designating the identified memory block as an active block.

13. The memory block management method of claim 1, further comprising:
determining whether an erase count of the selected memory block is less than an average block erase count for memory blocks in the nonvolatile memory device; and
performing a wear-leveling operation using the memory block property information where the erase count of the selected memory block is less than the average block erase count.

14. A memory system, comprising:
a nonvolatile memory device comprising multiple memory blocks and a meta area; and
a memory controller configured to control the nonvolatile memory device,
wherein the meta area stores erase count information, a ready-to-use list of memory blocks, a long term list of memory blocks, and memory block retry information for memory blocks in the ready-to-use list and the long term list;
wherein the memory controller performs a wear-leveling operation on the memory blocks using the erase count and the memory block retry information; and
wherein the ready-to-use list is a list of memory blocks each having a relatively low threshold voltage offset, the long term list is a list of memory blocks each having a relatively high threshold voltage offset, and the memory block retry information is obtained from read retry operations performed on the memory blocks in the ready-to-use list and the long term list.

16. The memory system of claim 16, wherein the memory block retry information indicates whether each of the memory blocks in the ready-to-use list and the long term list has a relatively low threshold voltage offset or a relatively high threshold voltage offset.

17. The memory system of claim 14, wherein free memory blocks are generated by erasing invalid memory blocks among the multiple memory blocks, and the free memory blocks are designated as ready-to-use blocks or long term blocks based on the memory block retry information.

18. The memory system of claim 14, wherein the ready-to-use list is a list of memory blocks each having a relatively low threshold voltage offset, and the long term list is a list of memory blocks each having a relatively high threshold voltage offset.

19. The memory system of claim 18, wherein a selected memory block to the ready-to-use list where a read retry operation of the selected memory block indicates that the selected memory block has a relatively low threshold voltage offset, and assigning the selected memory block to the long term list where the read retry operation indicates that the selected memory block has a relatively high threshold voltage offset.

20. The memory system of claim 18, wherein the ready-to-use list and the long term list are each arranged according to a threshold voltage offset of each memory block in those lists.
